(19) United States
(12) Patent Application Publication
(10) Pub. No.: US 2021/0157281 A1
(43) Pub. Date: May 27, 2021

(54) Intelligent PID control method

(71) Applicant: Changsha University of Science and Technology, Changsha (CN)

(72) Inventor: Zhezhao ZENG, Changsha (CN)

(21) Appl. No.: 17/169,495

(22) Filed: Feb. 7, 2021

Related U.S. Application Data
(63) Continuation of application No. PCT/CN2018/099809, filed on Aug. 10, 2018.

(51) Int. Cl. G05B 11/42

(52) U.S. Cl. CPC G05B 11/42

(57) ABSTRACT

For more than 80 years, although the traditional Proportional-integral-differential (PID) controller and all kinds of improved PID controller have been in the leading position in the field of industrial control, and played a huge role, but the tuning of the three gains for PID has been a prominent problem in the field of control theory and control engineering, and the lack of anti-disturbance ability. The intelligent PID or wisdom PID (WPID) control method of the invention establishes the tuning rule of three gains for PID controller through the speed factor irrelevant to the controlled system, which effectively solves the tuning problem of the three gains for the traditional PID, and has the global robust stability and good anti-disturbance robustness. The invention subverts the control theory system of nearly a century, and has a wide application value in the fields of electric power, transportation, machinery, chemical industry, light industry, aerospace etc.

### CROSS-REFERENCE TO RELATED APPLICATIONS

This application is a continuation of International Patent Application No. PCT/CN2018/099809, filed on Aug. 10, 2018. The content of the aforementioned applications, including any intervening amendments thereto, is incorporated herein by reference in its entirety.

### TECHNICAL FIELDS

The invention relates to a control method for a nonlinear uncertain system, in particular to an intelligent or wisdom proportional-integral-differential (WPID) control method.

### TECHNICAL BACKGROUND

For more than half a century, the classical control (cybernetics) method based on frequency domain design and the modern control (model theory) method based on time domain design have developed independently and formed their respective methodological systems. In the control engineering practice, the error between the control target and the actual behavior of the controlled object is easy to obtain, but also can be properly handled, so the proportional-integral-differential (PID) control strategy based on error to eliminate error has been widely used in the field of actual industrial control. For practical control engineering problems, it is often difficult to describe the internal mechanism, so the control strategy based on the modern control theory of mathematical model is difficult to be effectively applied in the actual control engineering. This is the disconnection between control engineering practice and control theory which has lasted for more than half a century and has not been solved well. The essence of classical control theory is to generate control strategy according to the deviation between the actual value and the control target. As long as the PID gains are reasonably tuned to make the closed-loop system stable, the control target can be achieved. This is the reason why it is widely used. However, the development of science and technology has put forward higher requirements for the accuracy, speed and robustness of the controller, and the disadvantages of PID control have gradually emerged: Although PID control can ensure the stability of the system, the dynamic quality of the closed-loop system is sensitive to the change of PID gains. This shortcoming leads to an irreconcilable contradiction between quickness and overshoot in the control system. Therefore, when the system operating conditions change, the controller gains also need to change, and this is the original motivation of various improved PID control methods, such as adaptive PID, nonlinear PID, neuron PID, intelligent PID, fuzzy PID, expert system PID and so on. Although a variety of improved PID controllers can improve the adaptive control ability of the system by on-line tuning of the PID gains, however, for the control problem of nonlinear uncertain system, the existing PID control is still powerless, especially the anti-disturbance ability is poor. In addition, the PID control principle is to form a control signal according to the weighted sum for the past (I), the present (P) and the future (change trend D) of error, although as long as the reasonable selection of PID three gains can exert effective control, however, the error and the integral and differential of the error are three physical quantities with completely different properties. The control signal formed by the independent weighted sum of the three dimensionless gains and the three physical quantities with different properties contains two theoretical defects: One is that it violates the rules of algebra, the second is that the control forces of three different attributes show their own uncoordinated control behavior in the process of control. Because of the inherent irrationality of PID, the experts, scholars and engineers in control theory and control engineering have been working hard on the tuning problem of PID gain for nearly a century. However, up to now, no solution with simple model structure, easy gain setting, good dynamic quality, high control precision and strong anti-disturbance ability has been found.

### INVENTION CONTENT

The technical problem to be solved by the invention is to overcome the above-mentioned defects existing in the prior art and provide an intelligent PID control method with simple model structure, easy parameter setting, good dynamic quality, high control precision and strong anti-disturbance ability.

Combined with the actual control of the inverted pendulum system, the present application provides an intelligent PID control method, comprising:

(1) according to the known desired output swing angular y_{d} and the known actual output swing angular y=y₁ in the inverted pendulum system, the tracking error e₁ of the swing angle and the integral e₀ of the error e₁ are established as follows:

e₁=y_{d}−y, e₀=∫₀^{t}e₁dτ

(2) after obtaining the swing angular error e₁ according to step (1), calculating the differential of the swing angular error to obtain the angular speed error e₂ as follows:

e₂=\dot{y}_{d}−y₂

Wherein, \dot{y}_{d} is the known desired angular speed and y₂=\dot{y}₁=\dot{y} is the known actual angular speed;

(3) after obtaining e₁, e₀ and e₂ according to the steps (1) and (2), the PID controller is designed as follows:

u=b₀⁻¹(ÿ_{d}+kₚe₁+kᵢe₀+k_{d}e₂)

where, b₀=1/J, and J is the moment of inertia; kₚ, kᵢ and k_{d} are the proportional gain, integral gain and differential gain of the PID controller respectively; ÿ_{d} is the known desired angular acceleration;

(4) according to the PID controller in step (3), the Wisdom PID or WPID tuning rule is defined as:

$$\{ \begin{matrix}{k}_{p} = 3 {z}_{c}^{2} - {σ}^{2} \\ {k}_{i} = {z}_{c} ( {z}_{c}^{2} - {σ}^{2} ) \\ {k}_{d} = 3 {z}_{c}\end{matrix}$$

where, z_{c} is the adaptive center speed factor and 0≤σ<z_{c} is the deviation of the adaptive center speed;

(5) according to the WPID tuning rule in step (4), in order to effectively avoid the overshoot and oscillation caused by integral saturation and differential peak value, the adaptive central speed factor z_{c} is defined as:

z_{c}=αh⁻¹(1−0.9e^{-βt})

where, h is the integral step size, 0<α<1 and 0<β<1.

The invention defines the controlled system dynamics, internal uncertainties and external disturbances as a total disturbance, an error dynamic system excited by the total disturbance is established according to the error between the desired output and the actual output of the controlled system, and then a PID controller model based on WPID tuning rule is designed. The WPID control system not only has robust stability with a large range, but also has a good anti-disturbance robustness.

The invention not only completely weakens the concepts of system classification such as linear and nonlinear, deterministic and uncertain, time-varying and time-invariant, but also adjusts the gains of WPID completely according to the speed factor, thus effectively solves the difficult problem of traditional PID gain tuning and realizes the wisdom PID control in the real sense.

In addition, the outstanding advantages of the invented WPID mainly include as follows:

(1) large range robust stability;

(2) parameter-free online optimization;

(3) simple structure, small amount of calculation and good real-time;

(4) fast response speed and high control precision;

(5) strong anti-disturbance ability.

### APPENDED DRAWINGS SHOW

FIG. 1 schematically shows an intelligent PID control system model

FIGS. 2A-C show a dynamic performance test result of a nonlinear uncertain system 1, where FIG. 2A shows a tracking control curve; FIG. 2B shows a control signal change curve; and FIG. 2C shows a tracking control error change curve.

FIGS. 3A-C show a dynamic performance test result of the inverted pendulum system, where FIG. 3A shows a tracking control curve of the swing angular and angular rate, FIG. 3B shows a control signal change curve of torque input, and FIG. 3C shows a tracking control error change curve of the swing angular.

FIGS. 4A-D show the anti-disturbance capability of the nonlinear uncertain system 1, where FIG. 4A shows a tracking control curve, FIG. 4B shows a control signal change curve, FIG. 4C shows a tracking control error change curve, and FIG. 4D shows an external disturbance signal.

FIGS. 5A-D show the anti-disturbance capability of the inverted pendulum system, where FIG. 5A shows a tracking control curve of the swing angular and angular rate, FIG. 5B shows a control signal change curve of torque input, FIG. 5C shows a tracking control error change curve of the swing angular, and FIG. 5D shows an external oscillation disturbance signal.

### SPECIFIC IMPLEMENTATION MODE

The specific implementation mode of the invention is described in detail in combination with the attached drawings and the inverted pendulum system.

1. Mapping Ideas from Nonlinear Uncertain System to Unknown Linear System

Let the model of a second-order nonlinear uncertain system be:

$$\{ \begin{matrix}{\dot{y}}_{1} = {y}_{2} \\ {\dot{y}}_{2} = f ( {y}_{1} , {y}_{2} , t ) + g ( {y}_{1} , {y}_{2} , t ) ( d + u ) \\ y = {y}_{1}\end{matrix} \qquad ( 1 )$$

where, y₁ and y₂ are the two states of the controlled system, u is the control input and y=y₁ is the actual output of the controlled system, f(y₁,y₂,t) and g(y₁,y₂,t) are smooth functions of the controlled system, respectively, and g(y₁,y₂,t) is a nonnegative function, d is the external disturbance.

In order to facilitate the practical application, the abstract controlled system (1) is combined with the actual inverted pendulum system (22) described by the subsequent simulation experiment plant 2 to illustrate the specific application of an intelligent PID control method of the present invention.

Consider an inverted pendulum system similar to system (1):

$$\{ \begin{matrix}{\dot{y}}_{1} = {y}_{2} \\ {\dot{y}}_{2} = - \frac{MgL}{2 J} sin ( {y}_{1} ) - \frac{{V}_{s}}{J} {y}_{2} + d + \frac{1}{J} u \\ y = {y}_{1}\end{matrix}$$

were y₁ is the swing angle, y₂ is the angular speed; g is the acceleration of gravity; M is the mass of swing rod; L is the length of the pendulum; J is the moment of inertia; Vₛ is the coefficient of viscous friction; D is the external disturbance and u is the torque input.

For an inverted pendulum system similar to system (1), the corresponding model functions are

$$f ( {y}_{1} , {y}_{2} , t ) = - \frac{MgL}{2 J} sin ( {y}_{1} ) - \frac{{V}_{s}}{J} {y}_{2} and g ( {y}_{1} , {y}_{2} , t ) = \frac{1}{J} .$$

An unknown total disturbance y₃ is defined as:

y₃=f(y₁,y₂,t)+d+g(y₁,y₂,t)u−b₀u (2)

then, an inverted pendulum system similar to system (1) can be mapped to the following unknown linear system:

$$\{ \begin{matrix}{\dot{y}}_{1} = {y}_{2} \\ {\dot{y}}_{2} = {y}_{3} + {b}_{0} u \\ y = {y}_{1}\end{matrix} \qquad ( 3 )$$

wherein, b₀≠0 is a control coefficient determined by a nonlinear function g(y₁,y₂,t), and b₀=1/J for an inverted pendulum system.

Since the unknown linear system (3) is the equivalent mapping of the nonlinear uncertain system (1), the effective controller formed by system (3) can realize the effective control of system (1).

The significance of the total disturbance is that any known or unknown complex nonlinear system can be mapped to the form of an unknown linear system (3). Not only that, since the definition of total disturbance also completely desalinizes the concept of system classification for linear and nonlinear, determining and uncertainties, time varying and invariance, affine and non affine and so on, thus it effectively solves the problems of how to apply effective control methods to the controlled system with different attributes in the last hundred years.

How to exert effective control on the unknown linear system (3) is the core technology of the invention, namely the WPID tuning technology.

2. Wisdom PID (WPID) Controller Design

For the control problem of an inverted pendulum system similar to an unknown linear system (3), according to the known desired and actual output angular of the inverted pendulum system, the tracking control error of the swing angular is established as follows:

e₁=y_{d}−y₁ (4)

Where, y_{d} is the known desired output angular, and y=y₁ is the known actual output angular.

Combined with system (3), differential e₂ and integral e₀ of the error are respectively:

e₂=ė₁=\dot{y}_{d}−\dot{y}₁=\dot{y}_{d}−y₂ (5)

e₀=∫₀^{t}e₁dτ (6)

Where, \dot{y}_{d} is the derivative of the swing angular, and is also the known the desired angular speed; y₂=\dot{y}₁=\dot{y} is the known actual angular speed in the inverted pendulum system.

Equation (5) is differentiated, and the differentiated Equation (5) was combined with the unknown linear system (3) to obtain an angular acceleration error Equation (7):

ė₂=ë₁=ÿ_{d}−y₃−b₀u (7)

Where, ÿ_{d} is the known desired angular acceleration, y₃ is an unknown total disturbance, and b₀=1/J.

Considering ė₀=e₁ and ė₁=e₂, combined with formula (7), a controlled error system is established as follows:

$$\{ \begin{matrix}{\dot{e}}_{0} = {e}_{1} \\ {\dot{e}}_{1} = {e}_{2} \\ {\dot{e}}_{2} = {\ddot{y}}_{d} - {y}_{3} - {b}_{0} u\end{matrix} \qquad ( 8 )$$

Obviously, the controlled error system (CES) (8) is a third-order error dynamic system (EDS). In order to make EDS stable, PID controller u and Wisdom PID (WPID) tuning rule are designed as follows:

u=(ÿ_{d}+kₚe₁+kᵢe₀+k_{d}e₂)/b₀ (9)

and WPID tuning rule:

$$\{ \begin{matrix}{k}_{p} = {z}_{1} {z}_{2} + {z}_{2} {z}_{3} + {z}_{1} {z}_{3} \\ {k}_{i} = {z}_{1} {z}_{2} {z}_{3} \\ {k}_{d} = {z}_{1} + {z}_{2} + {z}_{3}\end{matrix} \qquad ( 10 )$$

where, kₚ, kᵢ and k_{d} are the proportional gain, integral gain and differential gain of the PID controller respectively, and z₁>0, z₂>0 and z₃>0 are three speed factors respectively, and they all have dimensions of 1/second.

Since WPID tuning rule (10) is actually the dimensional conversion rule of three PID gains, therefore three speed factors not only established the dimension conversion relation for PID gains so as to make PID control law follow the dimension matching rule, but also established the internal relationship between the three gains so as to make the proportional control force, integration control force and differential control force with different properties can realize coordinated control behavior with different functions and consistent goals in the control process so as to solve the basic theoretical problems with two inherent defects for traditional PD.

3. WPID control System Analysis

Theorem 1. When |y₃|≤ε<∞, and z₁>0, z₂>0 and z₃>0, the WPID closed-loop control system formed by the WPID tuning rule (10) is robust and stable in a large range, and has good disturbance resistance robustness.

### Prove:

(1) Stability Analysis

By combining the WPID tuning rule (10), PID controller (9) and the controlled error system (8), an error dynamic system (EDS) excited by total disturbance inverse phase can be established:

$$\{ \begin{matrix}{\dot{e}}_{0} = {e}_{1} \\ {\dot{e}}_{1} = {e}_{2} \\ {\dot{e}}_{2} = - {y}_{3} - {k}_{p} {e}_{1} - {k}_{i} {e}_{0} - {k}_{d} {e}_{2}\end{matrix} \qquad ( 11 )$$

Take the Laplace Transform of formula (11), then:

$$\{ \begin{matrix}s {E}_{0} ( s ) = {E}_{1} ( s ) \\ s {E}_{1} ( s ) = {E}_{2} ( s ) \\ s {E}_{2} ( s ) = - {Y}_{3} ( s ) - {k}_{p} {E}_{1} ( s ) - {k}_{i} {E}_{0} ( s ) - {k}_{d} {E}_{2} ( s )\end{matrix} \qquad ( 12 )$$

The PID closed-loop control system can be obtained as follows:

(s³+k_{d}s²+kₚs+k)E₁(s)=−sY₃(s) (13)

By substituting the WPID tuning rule (10) into the PID closed-loop system (13), the WPID closed-loop system can be written as:

(s+z₁)(s+z₂)(s+z₃)E₁(s)=sY₃(s) (14)

Obviously, the WPID closed-loop system (14) is a third-order error dynamic system under the reverse phase excitation of unknown total disturbance, and its system transmission function is:

$$H ( s ) = \frac{{E}_{1} ( s )}{{Y}_{3} ( s )} = - \frac{s}{( s + {z}_{1} ) ( s + {z}_{2} ) ( s + {z}_{3} )} \qquad ( 15 )$$

According to the complex frequency domain analysis theory of the system, the WPID closed-loop system (15) is stable in a large range while three speed factors z₁>0, z₂>0 and z₃>0, and since the three speed factors have nothing to do with the model of the controlled system, the WPID closed-loop system (15) is robust stable in a large range.

(2) Anti-Disturbance Robustness Analysis

\textcircled{1} for z₁≠z₂≠z₃, the unit impulse response of the system is:

$$\begin{matrix}h ( t ) = {k}_{1} {e}^{- {z}_{1} t} + {k}_{2} {e}^{- {z}_{2} t} + {k}_{3} {e}^{- {z}_{3} t} , t > 0 \\ where & ( 16 ) \\ {k}_{1} = \frac{{z}_{1}}{( {z}_{2} - {z}_{1} ) ( {z}_{3} - {z}_{1} )} , {k}_{2} = \frac{{z}_{2}}{( {z}_{1} - {z}_{2} ) ( {z}_{3} - {z}_{2} )} and \\ {k}_{3} = \frac{{z}_{3}}{( {z}_{1} - {z}_{3} ) ( {z}_{2} - {z}_{3} )} . & \end{matrix}$$

Obviously, while z₁>0, z₂>0 and z₃>0, we have

$${lim}_{t \to ∞} h ( t ) = 0 and {lim}_{t \to ∞} \dot{h} ( t ) = 0.$$

For |y₃|≤ε<∞, we have

$${lim}_{t \to ∞} {e}_{1} ( t ) = {lim}_{t \to ∞} h ( t ) * {y}_{3} ( t ) = 0 and {lim}_{t \to ∞} {e}_{2} ( t ) = {lim}_{t \to ∞} \dot{h} ( t ) * {y}_{3} ( t ) = 0 ,$$

it is shown that the tracking error e₁(t) and its differential e₂(t)=ė₁(t) of the controlled system can approach the stable equilibrium origin (0,0) from any non-zero initial state uniformly.

The above analysis shows that WPID closed-loop system is not only robust and stable in a large range, but also can achieve precise control in theory for z₁≠z₂≠z₃ and z₁>0, z₂>0 and z₃>0, and |y₃|≤ε<∞.

\textcircled{2} for z₁=z₂=z₃=z_{c}>0, the unit impulse response of the system is:

h(t)=t(0.5z,t−1)e^{-z}^{_{c}}^{t}, t>0 (17)

Obviously, as z₁=z₂=z₃=z_{c}>0, we have

$${lim}_{t \to ∞} h ( t ) = 0 and {lim}_{t \to ∞} \dot{h} ( t ) = 0.$$

for |y₃|≤ε<∞, we have:

$${lim}_{t \to ∞} {e}_{1} ( t ) = {lim}_{t \to ∞} h ( t ) * {y}_{3} ( t ) = 0 and {lim}_{t \to ∞} {e}_{2} ( t ) = {lim}_{t \to ∞} \dot{h} ( t ) * {y}_{3} ( t ) = 0 ,$$

it is shown that the tracking error e₁(t) and its differential e₂(t)=ė₁(t) of the controlled system can approach the stable equilibrium origin (0,0) from any non-zero initial state uniformly.

The above analysis shows that WPID closed-loop system is not only robust and stable in a large range, but also can achieve precise control in theory for z₁=z₂=z₃=z_{c}>0 and |y₃|≤ε<∞. Because the robust stability of the WPID closed-loop system is independent of the specific model of the total disturbance, the WPID closed-loop system has good anti-disturbance robustness.

4. Speed Factor Tuning Method of WPID

Although Theorem 1 proves that the WPID closed-loop control system is robust and stable in a large range for z₁>0, z₂>0 and z₃>0, it shows that the three speed factors as z₁, z₂ and z₃ for WPID all have a large tuning margin. According to Equation (16), the larger zⱼ (j=1, 2, 3) is, the faster the unit impulse response approaches 0, and the three speed factors are required to be close or the same. For this purpose, set z₁=z_{c}−σ, z₂=z_{c}, z₃=z_{c}+σ and 0≤σ<z_{c}, respectively, wherein, z_{c} is the central speed factor and σ is the deviation of the central speed factor. Therefore, WPID tuning rule (10) is simplified as:

$$\{ \begin{matrix}{k}_{p} = 3 {z}_{c}^{2} - {σ}^{2} \\ {k}_{i} = {z}_{c} ( {z}_{c}^{2} - {σ}^{2} ) \\ {k}_{d} = 3 {z}_{c}\end{matrix} \qquad ( 18 )$$

where z_{c}>0 and 0≤σ<z_{c}.

In particular, while σ=0, we have z₁=z₂=z₃=z_{c}>0, and according to the tuning rule (18) of WPID, then:

$$\{ \begin{matrix}{k}_{p} = 3 {z}_{c}^{2} \\ {k}_{i} = {z}_{c}^{3} \\ {k}_{d} = 3 {z}_{c}\end{matrix} \qquad ( 19 )$$

According to WPID tuning rules (18) and (19), z_{c} is not only an important speed factor for tuning three PID gains as kₚ, kᵢ and k_{d}, but also an internal link factor among three different attribute links, such as proportion, integral and differential. It is the central speed factor that makes three different attribute links, such as proportion, integral and differential, form an indivisible organic unity so that the control forces of the three different attribute links can realize the coordinated control behaviors with different functions and consistent goals in the control process, which corrects the uncoordinated control behavior of the three different attributes of the traditional PID. According to the WPID tuning rule (18) or (19), compared with the traditional PID controller, the central speed factor of the invention establishes the theoretical system of PID gain tuning, and effectively solves the difficult problem of traditional PID tuning.

As z_{c}>0 and 0≤σ<z_{c}, the WPID tuning rule (18) or (19) can guarantee the large-scale robust stability of the WPID closed-loop system. In order to make the WPID control system have fast response speed and strong anti-disturbance ability, it is required that the larger the z_{c}, the better. However, if z_{c} is too large, the system will appear overshoot and oscillation due to the excessive integral control force, otherwise, the response speed and anti-disturbance ability of the system will be reduced. Therefore, the central speed factor of WPID is required to be reasonably tuned. The specific methods are as follows:

In order to effectively avoid overshoot and oscillation caused by integral saturation and differential peak value during the dynamic response process of the control system, the adaptive central speed factor is usually used, namely:

z_{c}=αh⁻¹(1−0.9e^{-βt}) (20)

where h is the integral step size, 0<α<1 and 0<β<1.

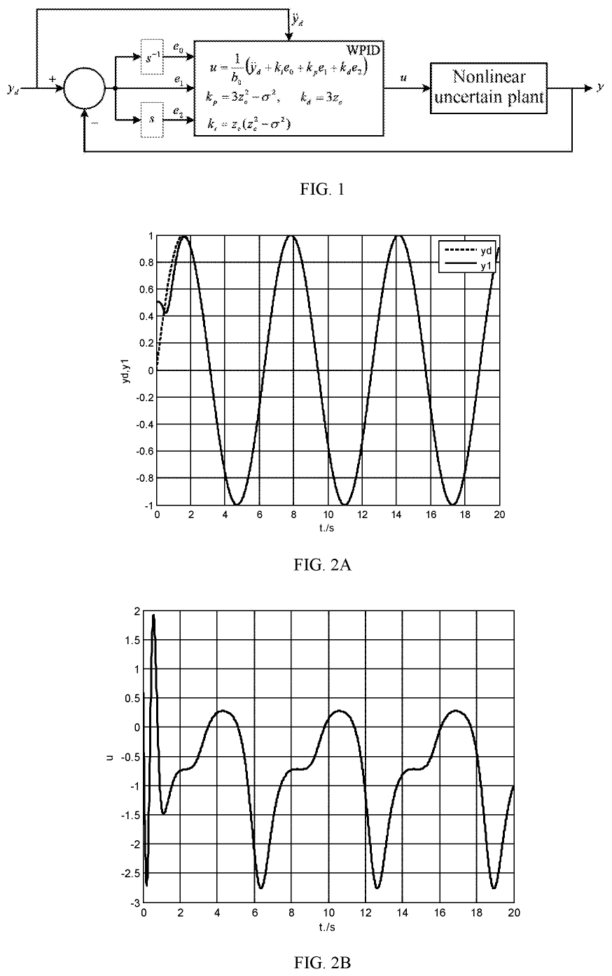

The block diagram of WPID control system is shown in FIG. 1.

5. Test and Analysis of WPID Control System

To verify the effectiveness of a WPID control method of the invention, The following simulation experiments are carried out for the control problem of nonlinear uncertain objects with two different models. The relevant simulation conditions of WPID controller are set as follows:

Let h=0.01, α=0.18, β=0.5 and σ=0.5, then z_{c}=18(1−0.9e^{-0.5t}). According to the gain tuning rule (18), k=3z_{c}²−0.25, kᵢ=z_{c}(z_{c}²−0.25) and k_{d}=3z_{c}.

In all the following simulation experiments, the gain parameters of WPID are exactly the same.

Set the first controlled plant be a nonlinear non-affine uncertain system as:

$$\{ \begin{matrix}{\dot{y}}_{1} = {y}_{2} \\ {\dot{y}}_{2} = f ( t , {y}_{1} , {y}_{2} ) + g ( t , {y}_{1} , {y}_{2} ) ( d + u ) \\ y = {y}_{1}\end{matrix} \qquad ( 21 )$$

where f(t,y₁,y₂)=e^{y}^{₂} cos(y₁), g(t,y₁,y₂)=1+sin²(t), d is the external disturbance.

Set the initial state as: y₁(0)=0.5 and y₂(0)=0, and let b₀=1 for 1≤g(t,y₁,y₂)≤2.

Set the second controlled plant be an inverted pendulum system as:

$$\{ \begin{matrix}{\dot{y}}_{1} = {y}_{2} \\ {\dot{y}}_{2} = - \frac{M g L}{2 J} sin ( {y}_{1} ) - \frac{{V}_{s}}{J} {y}_{2} + d + \frac{1}{J} u \\ y = {y}_{1}\end{matrix} \qquad ( 22 )$$

where y₁ is the swing angular, y₂ is the angular rate, g is the acceleration of gravity, M is the mass of swinging rod, L is the pendulum length, J=ML² is the moment of inertia, Vₛ is the coefficient of viscous friction, and d is an external disturbance.

Set g=9.8 m/s², Vₛ=0.18, M=1.1 kg, L=1 m, and the initial state as: y₁(0)=0.1π and y₂(0)=2; let b₀=1/J.

(1) Dynamic Performance Test

In order to verify the control performance of the wisdom PID control method, dynamic performance tests are carried out on the controlled objects of two different models as shown in the controlled object model (21) and (22) respectively, so as to test control performance about fast, accurate and stable for WPID.

Simulation Experiment 1. Test the Control Performance for the First Controlled System

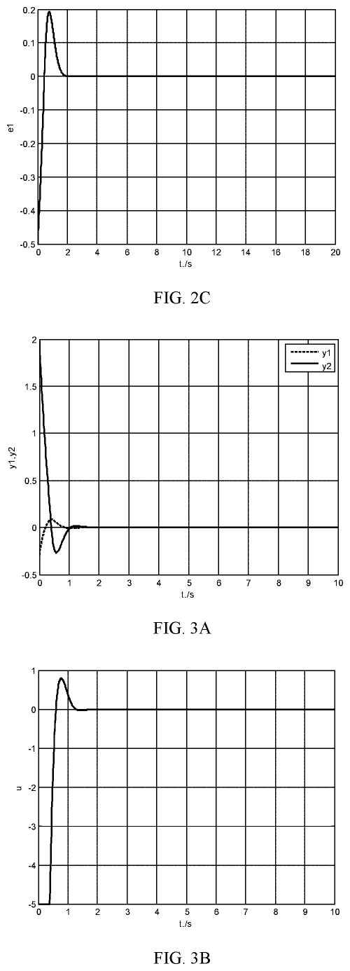

Let the expected output be y_{d}=sin(t), when there is no external disturbance, Test results of the control method of the invention are shown in FIG. 2. FIG. 2 shows that the wisdom PID controller of the invention has not only fast response speed and high control precision, but also strong robust stability, so it is an effective control method.

Simulation Experiment 2. Test the Control Performance Test for the Inverted Pendulum System

The control goal for the inverted pendulum is to make it approach the unstable equilibrium origin (0,0) as soon as possible from an arbitrary non-zero initial state (y₁⁰,y₂⁰).

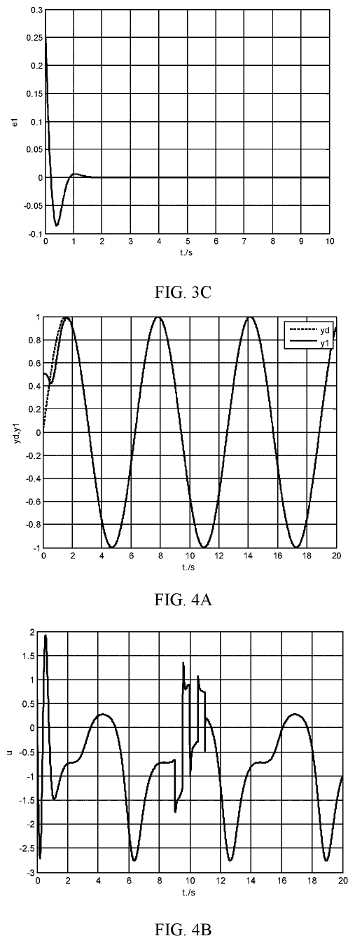

When there is no external disturbance, the simulation results of the control method of the invention are shown in FIG. 3. FIG. 3 shows that the inverted pendulum can approach the unstable equilibrium origin (0,0) from the initial state (−0.1π,2) after about 1.5 seconds, indicating that the wisdom PID controller of the invention not only has a fast response speed, but also can realize precise control, so it is an effective control method.

When there is no external disturbance, the above dynamic control performance test results show that using WPID with identical gain parameters to control two objects (21) and (22) with completely different models has achieved good control effect, which not only has the characteristics of fast response speed, high control precision, good robustness and stability, but also has a good versatility. Compared with all kinds of existing controllers, the invention reflects the unique advantages of the WPID control method.

(2) Anti-Disturbance Performance Test

In order to verify the anti-disturbance ability of the WPID control method of the invention, the anti-disturbance ability of the controlled objects with two different models as shown in system (21) and (22) is tested respectively. The test results are as follows:

Simulation Experiment 3. Test Anti-Disturbance Capability for the First Controlled System

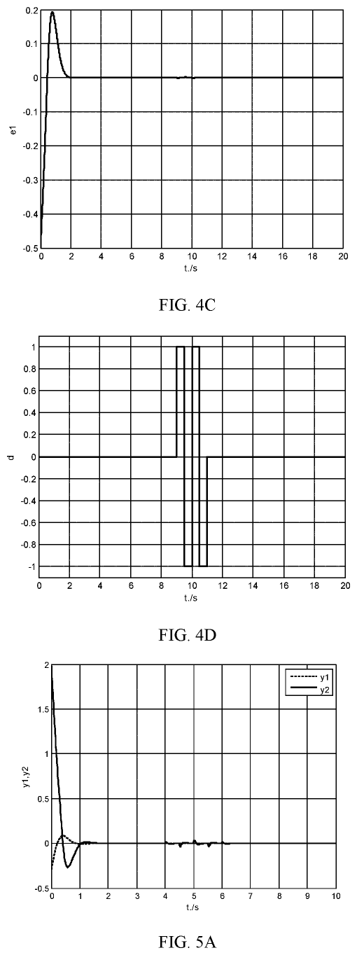

When there is external disturbance of square wave oscillation with amplitude of ±1 during (9 s˜11 s), set the expected output to be y_{d}=sin(t), the simulation results of the control method of the invention are shown in FIG. 4. FIG. 4 shows that the WPID of the invention has not only fast response speed and high control precision, but also strong robust stability and strong anti-disturbance ability, indicating that the WPID control method of the invention is a strong disturbance rejection control method.

Simulation Experiment 4. Test Anti-Disturbance Ability for the Inverted Pendulum System

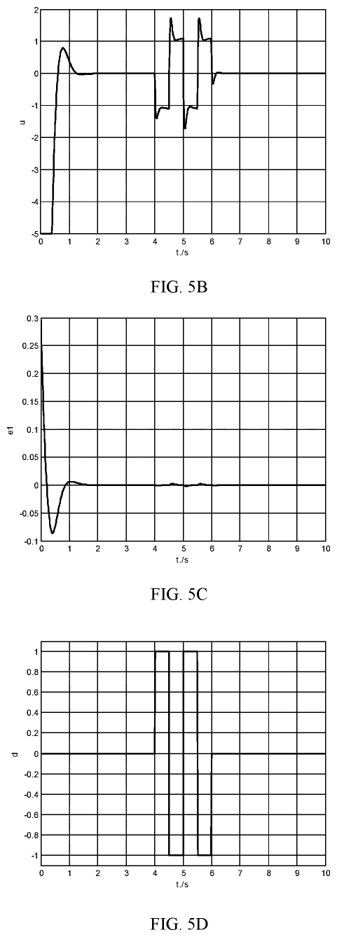

When there is external disturbance of square wave oscillation with amplitude of ±1 during (4 s˜6 s), the simulation results of the control method of the invention are shown in FIG. 5. FIG. 5 shows that the inverted pendulum can approach the unstable equilibrium origin (0,0) from the initial state (−0.1π,2) after about 1.5 seconds. It is further demonstrated that the WPID controller of the invention not only has a fast response speed and high control precision, but also has a good anti-disturbance robust stability. Once again, the WPID control method of the invention is a disturbance rejection control method with large range robust stability.

The above test results of anti-disturbance ability show that the WPID controller using the same adaptive central speed factor can achieve good anti-disturbance robust control effect on the controlled objects (21) and (22) with two different models.

6. Conclusions

Although PID controller, SMC and ADRC based on error to eliminate error are the three mainstream controllers widely used in the field of control engineering, however, the limitations of the traditional PID controller are also very obvious: firstly, the gain robustness is poor, so it is difficult to set the gain; the other is poor robustness against disturbance. Although all kinds of improved PID controllers, such as adaptive PID controller, nonlinear PID controller, parameter self-learning nonlinear PID controller, fuzzy PID controller, optimal PID controller, neuron PID controller, expert PID controller and so on to a large extent overcome parameter tuning problem for the traditional PID controller, the anti-disturbance robustness of the improved PID controller is still poor, and the computation is large. Although SMC has good robustness and stability, there is an irreconcilable contradiction between high frequency chattering and anti-disturbance ability. Although ADRC has good stability performance and strong anti-disturbance ability, however, there are too many controller parameters, too much calculation of related nonlinear functions, complex control system structure, and difficult to analyze the stability of the control system.

Compared with the existing three mainstream controllers, the WPID control method of the invention concentrates the respective advantages of the three mainstream controllers and eliminates their limitations, namely, it has the advantages of simple PID structure, good robustness and stability of SMC, and strong anti-disturbance ability of ADRC, which it not only effectively avoids the difficulty of PID parameter tuning, but also effectively solves the problem that SMC can not be reconcilable between high frequency chattering and anti-disturbance ability, and also effectively avoids the problem that ADRC controller has too many parameters and too much calculation. The invention of WPID control method has completely overthrown the control theory system for nearly a century, which makes the scholars and engineers who are engaged in the research of control theory and control engineering can get a thorough liberation from the complicated gain tuning research work.

The invention has wide application value in electric power, transportation, machinery, chemical industry, light industry, aerospace and other fields.

What is claimed is:

1. Combined with the actual control of the inverted pendulum system, an intelligent PID control method, comprising:
(1) according to the known desired output swing angular y_{d} and the known actual output swing angular y=y₁ in the inverted pendulum system, the tracking error e₁ of the swing angle and the integral e₀ of the error e₁ are established as follows:
e₁=y_{d}−y, e₀=∫₀^{t}e₁dτ
(2) after obtaining the swing angular error e₁ according to step (1), calculating the differential of the swing angular error to obtain the angular speed error e₂ as follows:
e₂=\dot{y}_{d}−y₂
Wherein, \dot{y}_{d} is the known desired angular speed and y₂=\dot{y}₁=\dot{y} is the known actual angular speed;
(3) after obtaining e₁, e₀ and e₂ according to the steps (1) and (2), the PID controller is designed as follows:
u=b₀⁻¹(ÿ_{d}+kₚe₁+kᵢe₀+k_{d}e₂)
where, b₀=1/J, and J is the moment of inertia; kₚ, kᵢ and k_{d} are the proportional gain, integral gain and differential gain of the PID controller respectively; ÿ_{d} is the known desired angular acceleration;
(4) according to the PID controller in step (3), the Wisdom PID or WPID tuning rule is defined as:
$$\{ \begin{matrix}{k}_{p} = 3 {z}_{c}^{2} - {σ}^{2} \\ {k}_{i} = {z}_{c} ( {z}_{c}^{2} - {σ}^{2} ) \\ {k}_{d} = 3 {z}_{c}\end{matrix}$$
where, z_{c} is the adaptive center speed factor and 0≤σ<z_{c} is the deviation of the adaptive center speed;
(5) according to the WPID tuning rule in step (4), in order to effectively avoid the overshoot and oscillation caused by integral saturation and differential peak value, the adaptive central speed factor z_{c} is defined as:
z_{c}=αh⁻¹(1−0.9e^{-βt})
where, h is the integral step size, 0<α<1 and 0<β<1.
